(19) United States
(12) Patent Application Publication
(10) Pub. No.: US 2013/0319608 A1
(43) Pub. Date: Dec. 5, 2013

(54) METHODS OF COATING AN ELECTROLYTE LAYER ON A SUBSTRATE AND METHODS OF MANUFACTURING ELECTROWETTING DISPLAY BY USING THE SAME

(71) Applicants: Il-Sup CHOI, Hwaseong-si (KR); Sin KWON, Suwon-si (KR); Sung-Gun LEE, Seongnam-si (KR); Joong-Ha LEE, Suwon-si (KR); Sang-Jin CHOI, Yongin-si (KR); Dong-Woo PAENG, Anyang-si (KR)

(72) Inventors: Il-Sup CHOI, Hwaseong-si (KR); Sin KWON, Suwon-si (KR); Sung-Gun LEE, Seongnam-si (KR); Joong-Ha LEE, Suwon-si (KR); Sang-Jin CHOI, Yongin-si (KR); Dong-Woo PAENG, Anyang-si (KR)

(21) Appl. No.: 13/763,891

(22) Filed: Feb. 11, 2013

(30) Foreign Application Priority Data
Jun. 5, 2012 (KR) 10-2012-0060642

(51) Int. Cl. H05B 33/10

(52) U.S. Cl. CPC H05B 33/10
USPC 156/273.3; 427/66; 156/60

(57) ABSTRACT

A method of coating an electrolyte layer on a substrate includes forming a hydrophobic layer on an upper surface of the substrate that has a coating area, forming a hydrophilic region having a shape surrounding an outside of the coating area, and forming the electrolyte layer to cover the hydrophobic layer and the hydrophilic region.

### CROSS-REFERENCE TO RELATED APPLICATION

This application claims priority under 35 USC §119 to Korean Patent Application No. 10-2012-0060642 filed on Jun. 5, 2012 in the Korean Intellectual Property Office (KIPO), and entitled: “Method of Coating An Electrolyte Layer On A Substrate and Methods of Manufacturing Electrowetting Display By Using the Same,” the entire disclosure of which is incorporated herein by reference.

### BACKGROUND

An electrowetting display (EWD) has been newly introduced. The EWD uses the principles of hydrophobic and hydrophilic interactions to display images.

### SUMMARY

Embodiments may be realized by providing a method of coating an electrolyte layer on a substrate that includes forming a hydrophobic layer on an upper surface of the substrate that has a coating area, forming a hydrophilic region having a shape surrounding an outside of the coating area, and forming the electrolyte layer to cover the hydrophobic layer and the hydrophilic region.

Forming the hydrophilic region may include forming a hydrophilic layer on the hydrophobic layer. Forming the hydrophilic region may include removing portions of the hydrophobic layer in the hydrophilic region. The hydrophilic region may be positioned outside the substrate and may be formed to surround sidewalls of the substrate. The hydrophilic region may be positioned at an upper surface of a chuck for surrounding at least a portion of the sidewalls of the substrate and for supporting a bottom of the substrate.

Forming the electrolyte layer may include moving the substrate in a lateral direction while an electrolyte discharged from one end portion of a nozzle is provided to the upper surface of the substrate. Forming the electrolyte layer may include allowing the electrolyte to cover the hydrophobic layer while the electrolyte has a relatively strong adhesion to the hydrophilic region.

Embodiments may also be realized by providing a method of manufacturing an electrowetting display that includes forming a hydrophobic insulation layer on a first substrate having a pixel region, in which the pixel region includes pixel electrodes formed on the first substrate, forming a hydrophilic region having a shape surrounding an outside of the pixel region, forming oil patterns on portions of the first substrate corresponding to the pixel electrodes, respectively, forming an electrolyte coating layer on the oil patterns, the electrolyte coating layer being formed to cover the hydrophobic insulation layer and the hydrophilic region, and covering the first substrate with a second substrate.

Forming the hydrophilic region may include forming a hydrophilic layer on the hydrophobic insulation layer. The hydrophilic region may be positioned outside the substrate and may be formed to surround sidewalls of the substrate. A surface of the hydrophobic insulation layer may be exposed outside the hydrophilic region.

The hydrophilic region may be formed by attaching a thin film, which thin film includes a material having a hydrophilic group, onto the hydrophobic insulation layer. Forming the hydrophilic region may include forming a thin film, which thin film includes a material having a hydrophilic group, on the substrate, and patterning the thin film through a photolithography process.

Forming the electrolyte coating layer may include forming an electrolyte layer by allowing the electrolyte to completely cover the hydrophobic layer while the electrolyte has a relatively strong adhesion to the hydrophilic region. The method may include forming isolation walls on the hydrophobic insulation layer, the isolation walls corresponding to pixel boundaries, respectively, in the pixel region. The oil patterns may be formed on portions of the hydrophobic layer isolated by the isolation walls. The isolation walls may include a material having a higher hydrophilicity than the hydrophobic insulation layer.

Embodiments may also be realized by providing a method of manufacturing an electrowetting display that includes providing a first substrate having a pixel region formed thereon, the pixel region including a plurality of pixels, forming a hydrophobic insulation layer above the pixel region, forming a hydrophilic region in a non-overlapping relationship with the pixel region, forming oil patterns that are above the pixel region and excluded from being above the hydrophilic region, forming a single electrolyte coating layer covering the hydrophobic insulation layer, the oil patterns, and the hydrophilic region, and providing a second substrate on the first substrate to enclose the electrolyte coating layer between the first and second substrates.

The electrolyte coating layer may be directly on the hydrophobic insulation layer, the oil patterns, and the hydrophilic region. The method may include forming isolation walls that overlap the pixel region, and each of the oil patterns may be arranged between adjacent ones of the isolation walls. The isolation walls may define secondary hydrophilic regions that are on the hydrophobic insulation layer and that are enclosed by the hydrophilic region. The electrolyte coating layer may be directly on uppermost sides of the oil patterns and the isolation walls, and the electrolyte coating layer may be in direct contact with a hydrophilic surface within the hydrophilic region.

The hydrophilic region may be defined by a hydrophilic layer formed on the hydrophobic insulation layer or by an exposed portion of the substrate, the electrolyte coating layer may cover an uppermost side of the hydrophilic layer or the exposed portion of the substrate, and a closed-loop shape of the hydrophilic region may enclose the oil patterns. The method may include forming isolation walls that overlap the pixel region, and each of the oil patterns may be arranged between adjacent ones of the isolation walls. The isolation walls may define secondary hydrophilic regions enclosed by the hydrophilic region.

### BRIEF DESCRIPTION OF THE DRAWINGS

Features will become apparent to those of ordinary skill in the art by describing in detail exemplary embodiments with reference to the attached drawings in which:

Example embodiments will be more clearly understood from the following detailed description taken in conjunction with the accompanying drawings. FIGS. 1A to 16C represent non-limiting, example embodiments as described herein.

FIGS. 1A to 1C are cross-sectional views illustrating a coating method in accordance with an example embodiment;

FIG. 2 is a perspective view illustrating a coating method in accordance with an example embodiment;

FIG. 3A illustrates an electrolyte on a hydrophobic layer;

FIG. 3B illustrates the electrolyte on a lower thin film including a hydrophilic layer at edges of the hydrophobic layer;

FIGS. 4A to 4H illustrate cross-sectional views depicting stages in a method of manufacturing an electrowetting display in accordance with an example embodiment;

FIGS. 5 and 6 illustrate a cross-sectional view and a perspective view, respectively, of a stage in a coating method in accordance with an example embodiment;

FIGS. 7A and 7B illustrate cross-sectional views depicting stages in a method of manufacturing an electrowetting display in accordance with an example embodiment;

FIGS. 8A and 8B illustrate cross-sectional views depicting stages in a coating method in accordance with an example embodiment;

FIGS. 9A and 9B illustrate cross-sectional views depicting stages in a method of manufacturing an electrowetting display in accordance with an example embodiment;

FIGS. 10A and 10B illustrate cross-sectional views depicting stages in a coating method in accordance with an example embodiment;

FIGS. 11A and 11B illustrate cross-sectional views depicting stages in a method of manufacturing an electrowetting display in accordance with an example embodiment;

FIGS. 12A and 12B illustrate perspective views depicting stages in a coating method in accordance with an example embodiment;

FIGS. 13A and 13B illustrate cross-sectional views depicting stages in a coating method in accordance with an example embodiment;

FIGS. 14A and 14B illustrate cross-sectional views depicting stages in a method of manufacturing an electrowetting display in accordance with an example embodiment;

FIGS. 15A and 15B illustrate cross-sectional views depicting stages in a coating method in accordance with an example embodiment; and

FIGS. 16A to 16C illustrate cross-sectional views depicting stages in a method of manufacturing an electrowetting display in accordance with an example embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawings, the sizes and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, e.g., of manufacturing techniques and/or tolerances, are to be expected. Thus, example embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the embodiments.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

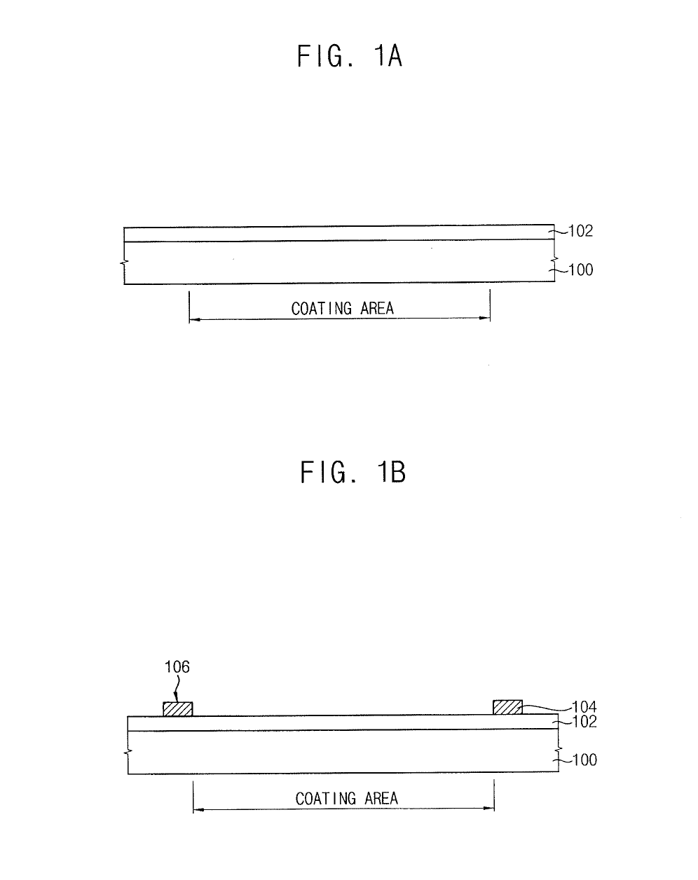

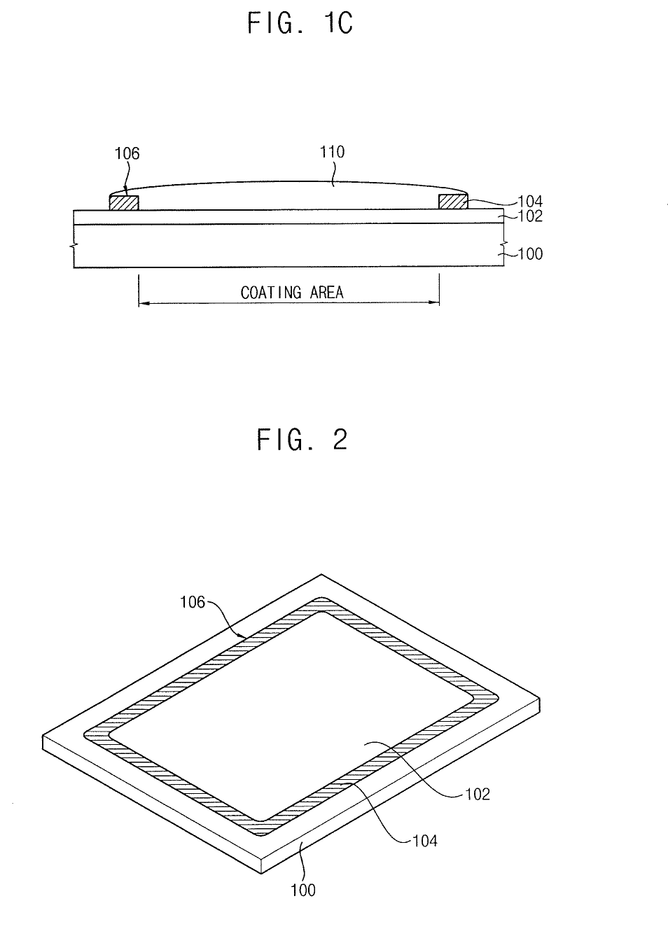

FIGS. 1A to 1C are cross-sectional views illustrating a coating method in accordance with an example embodiment. FIG. 2 is a perspective view illustrating a coating method in accordance with an example embodiment.

Hereinafter, a method of forming an electrolyte layer on a hydrophobic layer will be described.

Referring to FIG. 1A, a hydrophobic layer 102 may be formed on the entire upper surface of a substrate 100. The substrate 100 may include, e.g., a glass substrate. A surface, e.g., the upper surface, of the substrate 100 may be hydrophilic. The substrate 100 may include a portion (hereinafter, referred to as “coating area”) that is to be later coated with an electrolyte layer. For example, a central portion of the substrate 100 may be the coating area. According to an exemplary embodiment, an entirety of the central portion of the substrate 100 may define the coating area, such that an entire periphery of the coating area is surrounded by a non-coating area of the substrate 100 (e.g., which non-coating area corresponds to edges of the substrate 100 or is near each of the edges of the substrate 100).

The hydrophobic layer 102 may be formed through a spin coating process, or may be formed by an inkjet spraying method or deposition. The hydrophobic layer 102 may be formed by using an organic insulation material. The hydrophobic layer 102 may be formed through coating with a fluororesin. For example, the hydrophobic layer 102 may be formed through coating the substrate 100 with Teflon® AF1600 (DuPont product Teflon® AF1600) or CYTOP (Asahi Glass Co., Ltd, Japan).

Referring to FIGS. 1B and 2, a hydrophilic region 106 may be formed by forming a hydrophilic layer 104 to surround the outside, e.g., and an entirety of the periphery, of the coating area on the substrate 100. The hydrophilic region 106 may be formed on the hydrophobic layer 102 and may be excluded from the coating area. The placement of hydrophilic region 106 may define the periphery of the coating area so that the hydrophilic region 106 forms the boundary between the coating area and the non-coating area. A surface of the hydrophilic region 106 may be hydrophilic in comparison to the hydrophobic layer 102. Therefore, a surface of the hydrophilic region 106 may be distinguished from a surface of the hydrophobic layer 102.

The hydrophilic layer 104 may have different characteristics, and may be different material, from the hydrophobic layer 102. For example, the hydrophilic layer 104 may have a greater hydrophilic effect than the hydrophobic effect of the hydrophobic layer 102, and the hydrophobic layer 102 may have a greater hydrophobic effect than the hydrophilic effect of the hydrophilic layer 104. The hydrophilic layer 104 may be formed by attaching an insulation material layer having a hydrophilic group to the hydrophilic region 106. As another example, the hydrophilic layer 104 may be formed by depositing an insulation material layer having a hydrophilic group on the entire upper surface of the hydrophobic layer 102 and patterning the insulation material layer.

As shown in FIG. 2, the hydrophilic region 106 may have a closed-loop shape. The hydrophobic layer 102 may be exposed at an edge portion of the substrate 100 outside the hydrophilic region 106, which edge portion is outside of a pixel region of the substrate 100.

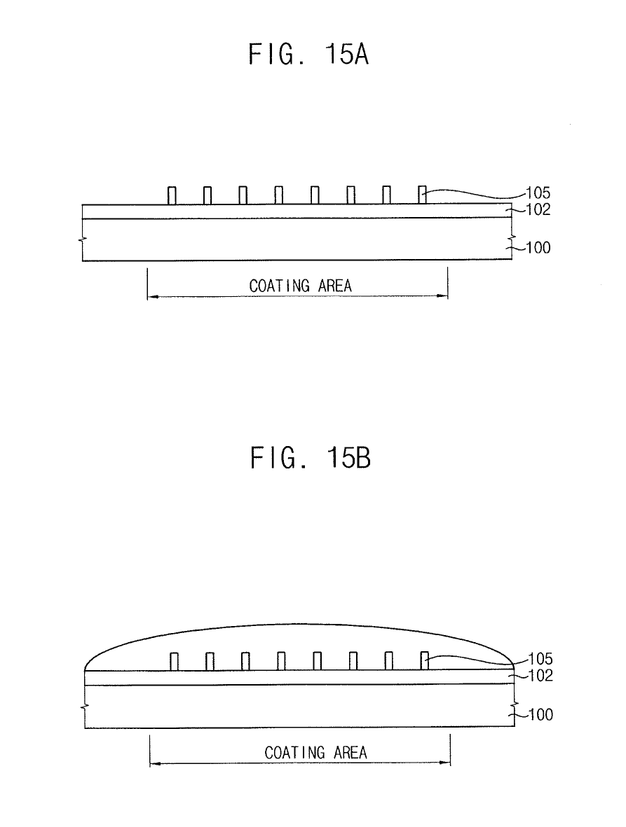

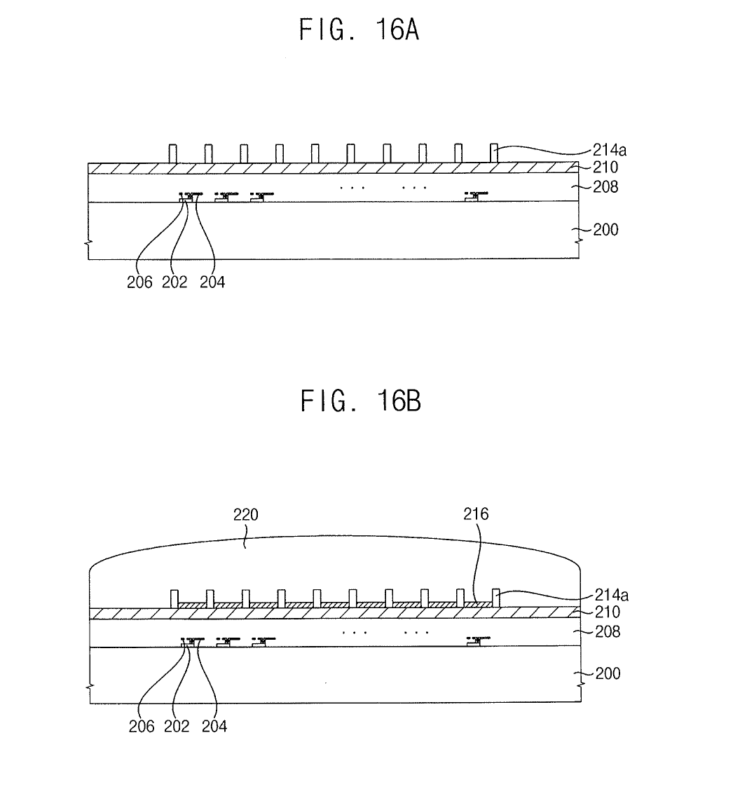

In addition, as shown in FIG. 15A, which is discussed in detail later, a process of forming isolation walls, which have hydrophilicity compared to the hydrophobic layer even in the coating area, may be further included. For example, surfaces of the isolation walls may also become additional hydrophilic regions.

Referring to FIG. 1C, an electrolyte layer 110 may be formed by using an electrolyte to coat and cover the hydrophobic layer 102 and the hydrophilic region 106. For example, the electrolyte layer 110 may be formed by slit coating. The electrolyte layer 110 may include the electrolyte.

According to an exemplary embodiment, the electrolyte may be provided to the upper surface of the substrate 100 through an outlet of a slit nozzle, and the substrate 100 may be moved in a lateral direction. Therefore, the entire coating area or the entire surface of the substrate 100 may be coated with the electrolyte.

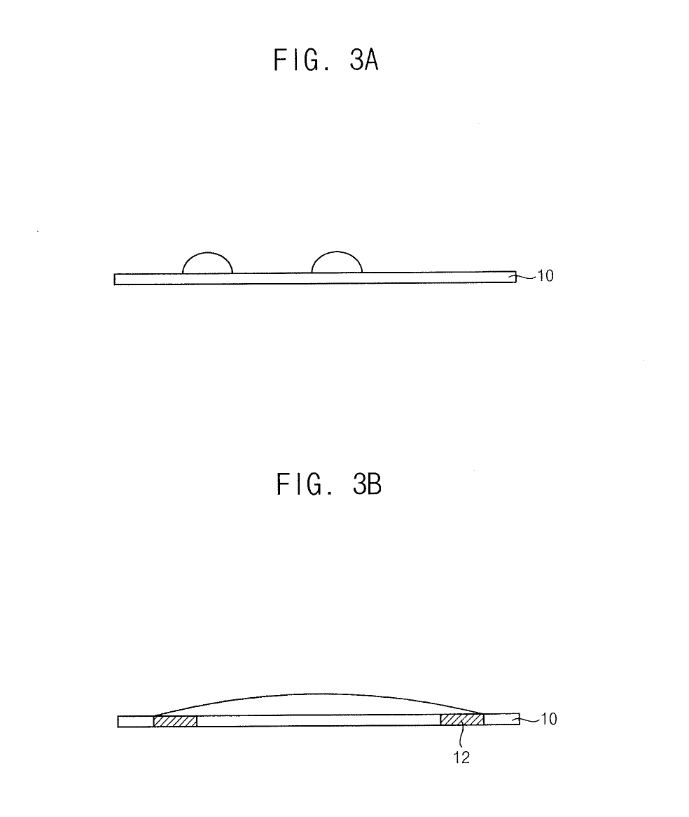

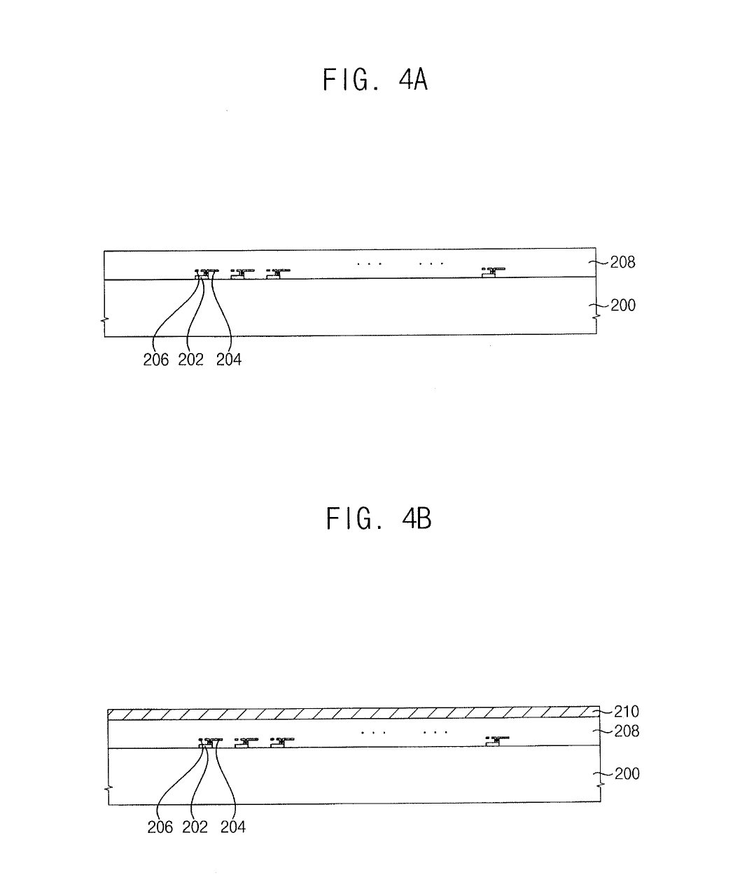

FIG. 3A illustrates an electrolyte on a hydrophobic layer 10. FIG. 3B illustrates the electrolyte on a lower thin film including a hydrophilic region 12 near edges of the hydrophobic layer 10.

As shown in FIG. 3A, the adhesion of the electrolyte to the hydrophobic layer 10 may be very weak. Thus, the electrolyte may be in contact with the hydrophobic layer 10 while having a relatively high contact angle. Therefore, the electrolyte may contract in the form of a drop on the hydrophobic layer 10. For example, sidewalls of the electrolyte may have a steep incline to form a semi-hemispherical shape concentrated on the hydrophobic layer 10.

As shown in FIG. 3B, the electrolyte may be formed to cover, e.g., entirely cover, the hydrophobic layer 10 and a hydrophilic region 12 near the edges of the hydrophobic layer 10. The electrolyte may be excluded on the edges of the hydrophobic layer 10. A contact angle of the electrolyte on the hydrophobic layer 10 and the hydrophilic region 12 may be lower than that of the electrolyte on only hydrophobic layer 10. For example, sidewalls of the electrolyte may have a gradual incline to form an elongated curved shape extending across the hydrophilic region 12 and the hydrophobic layer 10.

When the electrolyte is formed to cover both the hydrophobic layer 10 and the hydrophilic region 12, according to exemplary embodiments, the hydrophobic layer 10 and the hydrophilic region 12 may be affected by different amounts of surface tension.

For example, the electrolyte may have a shape covering the hydrophobic layer while strongly attaching to the hydrophilic region 12. Also, the electrolyte layer 110 may be formed to cover the upper surface of the hydrophobic layer 10 while not contracting in the form of a drop and having a low contact angle. Therefore, the possibility of dewetting defects being generated due to the contraction of the electrolyte may be reduced and/or prevented.

Further, an amount of the electrolyte used may be reduced when the electrolyte layer is formed in a manner to reduce dewetting defects. For example, an electrolyte layer having virtually no dewetting defects may be formed by using a small amount of the electrolyte according to the foregoing method. Hereinafter, a method of manufacturing an electrowetting display including the foregoing coating method will be described.

Method of Manufacturing Electrowetting Display

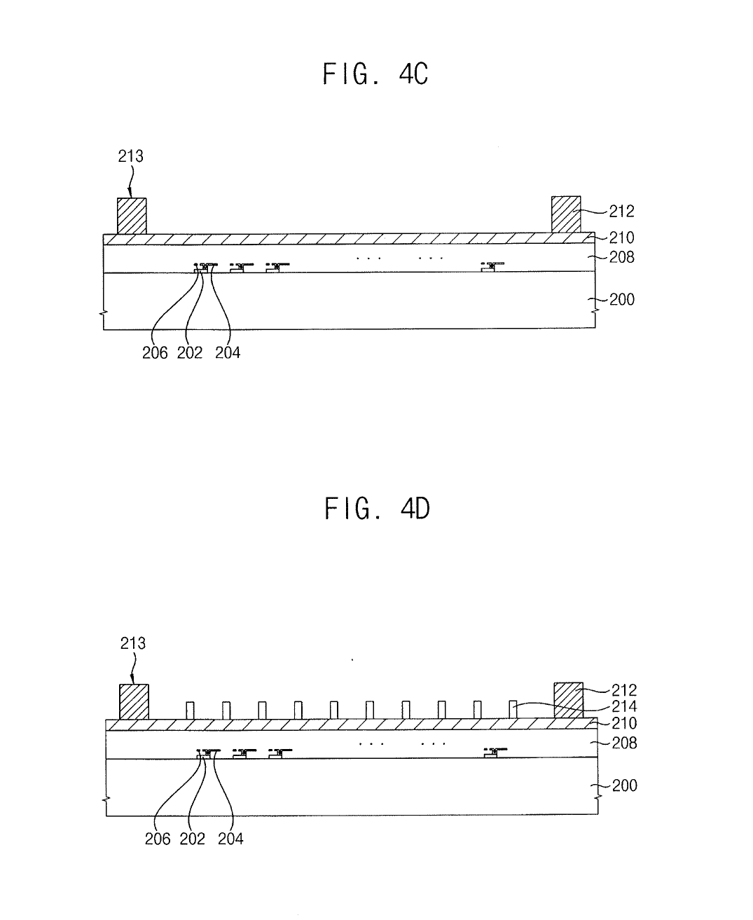

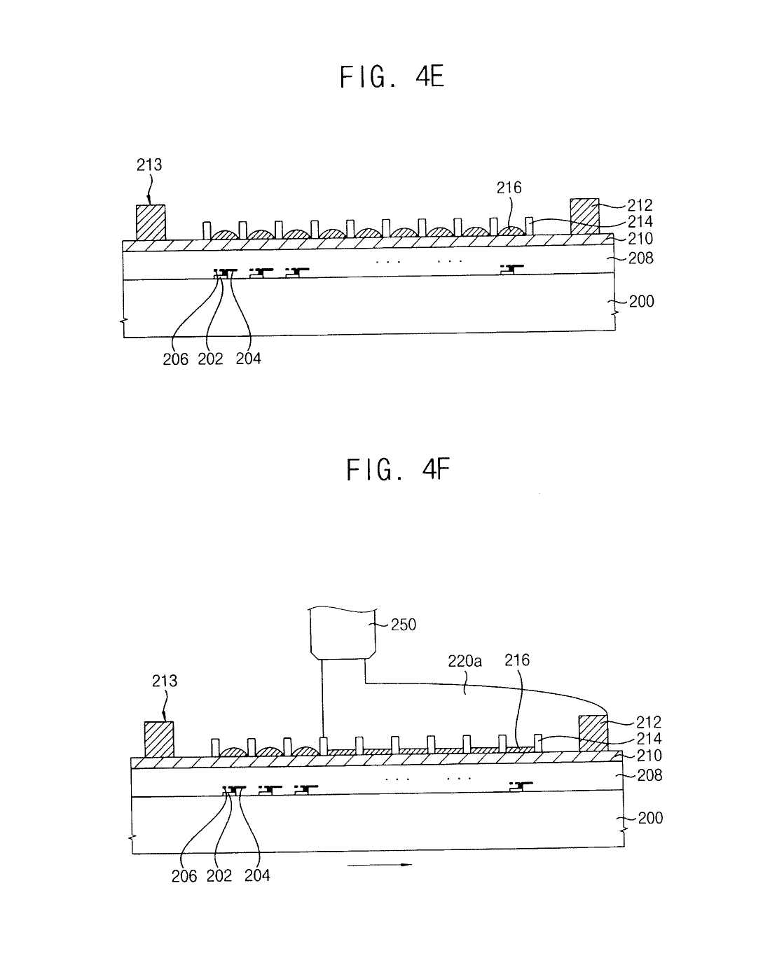

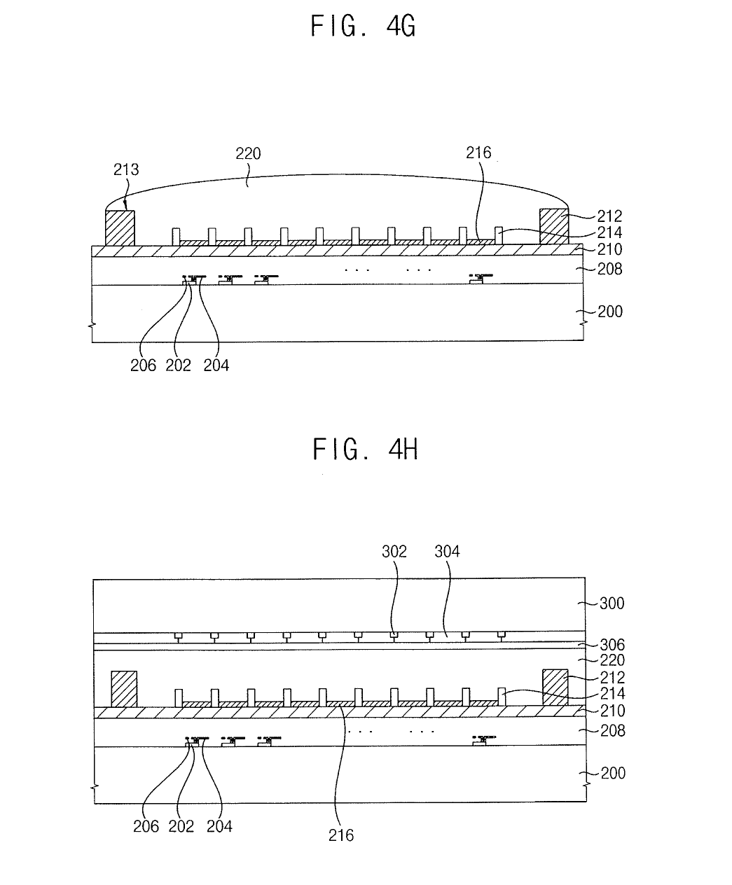

FIGS. 4A to 4H illustrate cross-sectional views depicting stages in a method of manufacturing an electrowetting display in accordance with an example embodiment.

Referring to FIG. 4A, a thin film transistor 202, a pixel electrode 204, a notch electrode 206, and an insulation layer 208 may be formed in a pixel forming region included on a first substrate 200. The first substrate 200 may include, e.g., a glass substrate. A surface of the first substrate 200 may be hydrophilic.

A plurality of pixels may be formed in the pixel forming region of the first substrate 200. The thin film transistor 202, the pixel electrode 204, and the notch electrode 206 may be included in a single pixel in the pixel forming region. The insulation layer 208 may be formed to cover the thin film transistor 202, the pixel electrode 204, and the notch electrode 206 of each of the plurality of pixels. The pixel electrode 204 and the notch electrode 206 may be formed by patterning a single electrode layer.

Referring to FIG. 4B, a hydrophobic insulation layer 210 may be formed to cover a surface, e.g., the entire upper surface, of the first substrate 200. For example, the hydrophobic insulation layer 210 may be formed directly on the insulation layer 208, and may be spaced apart from each of the plurality of pixels. The hydrophobic insulation layer 210 may be formed to cover the pixel electrode 204 and the notch electrode 206.

The hydrophobic insulation layer 210 may be formed through a spin coating process, or may be formed by an inkjet spraying method or deposition. The hydrophobic insulation layer 210 may be formed by using an organic insulation material. The hydrophobic insulation layer 210 may be formed through coating with a fluororesin. For example, the hydrophobic insulation layer 210 may be formed through coating the first substrate 200 with Teflon® AF1600 (DuPont product Teflon® AF1600) or CYTOP (Asahi Glass Co., Ltd, Japan).

Referring to FIG. 4C, a hydrophilic region 213 may be formed by forming a hydrophilic layer 212 to surround the outside, e.g., a periphery, of the pixel forming region. The hydrophilic layer 212 may include an insulation material having a hydrophilic group so that the hydrophilic layer 212 has a different effect with respect to hydrophilicity than the hydrophobic insulation layer 210. The hydrophilic layer 212 may be formed by attaching an insulation material film having a hydrophilic group to the hydrophilic region 213.

As another example, an insulation material layer having a hydrophilic group may be formed on the entire upper surface of the hydrophobic insulation layer 210 and the hydrophilic layer 212 may be formed by patterning the insulation material layer through a photolithography process so as to allow the hydrophilic layer to remain only in the hydrophilic region 213.

Similarly to the hydrophilic region 106 shown in FIG. 2, the hydrophilic region 213 may have a closed-loop shape. Similarly to the hydrophobic layer 102 shown in FIG. 2, the hydrophobic insulation layer 210 may be exposed at an edge portion of the first substrate 200 outside the hydrophilic region 213.

The hydrophilic layer 212 may be provided to improve the adhesion characteristics of an electrolyte coating layer to be subsequently formed. Therefore, the hydrophilic layer 212 may have a small thickness, but the range of the thickness thereof may not be limited thereto. The thickness of the hydrophilic layer 212 may be less than a thickness of the electrolyte coating layer 220 to be subsequently formed, e.g., so that the electrolyte coating layer covers an uppermost surface of the hydrophilic layer 212.

Referring to FIG. 4D, isolation walls 214 may be formed on, e.g., directly on, the hydrophobic insulation layer 210. The isolation walls 214 may be provided in an isolated inner space for each pixel, e.g., each of the isolation walls 214 may overlap an isolation space between adjacent pixels. That is, the inner spaces formed by the isolation walls 214 may correspond to the respective pixels, e.g., adjacent isolation walls 214 may define one pixel thereunder. The isolation walls 214, e.g., may include a photoresist.

The isolation walls 214 may be formed to have hydrophilicity, e.g., that isolation walls 214 may define secondary hydrophilic regions. For example, the isolation walls 214 may include a material having hydrophilicity. The hydrophilic material may have a higher hydrophilicity than the hydrophobic insulation layer 210 thereunder. According to an exemplary embodiment, the isolation walls 214 may be formed by a selective hydrophilic treatment of the isolation walls 214. For example, surfaces of the isolation walls 214 may be provided as additional hydrophilic regions.

A process of forming the isolation walls 214 and a process of forming the hydrophilic region 213 may be performed in an altered sequence, e.g., the isolation walls 214 may be formed before the hydrophilic layer 212. The hydrophilic layer 212 may be formed to have a greater height than the isolation walls 214, e.g., a distance from the uppermost surface of the hydrophilic layer 212 to the upper surface of the substrate 200 may be greater than a distance from the uppermost surface of each of the isolation walls 214 to the upper surface of the substrate 200.

Referring to FIG. 4E, each inner space foimed by the isolation walls 214 may be coated with oil to form oil patterns 216. The oil may be coated by using an inkjet spraying method. When coated with the oil, the oil patterns 216 may be formed as the oil to come into contact with upper surfaces of the hydrophobic insulation layer 210 between adjacent ones of the isolation walls 214. The oil patterns 216 correspond to the plurality of pixels, respectively.

The oil patterns 216 may act to permit or block the transmission of light. Also, the oil patterns 216 may act to reduce the possibility of and/or prevent the reflection of external light by blocking or absorbing the external light incident from the outside.

As another example, the oil patterns 216 may be configured to show colors, e.g., to show a red, green, or blue color, respectively. In this case, the oil patterns 216 may function as a color filter so that a color filter may be omitted.

Referring to FIGS. 4F and 4G, an electrolyte coating layer 220 may be formed on the oil patterns 216 to cover the hydrophobic insulation layer 210 and the hydrophilic region 213. When the electrolyte coating layer 220 is formed, the oil patterns 216 may come into contact with the hydrophobic insulation layer 210 as the oil patterns 216 are forced downward by the application of the electrolyte coating layer 220.

The electrolyte 220a, as shown in FIG. 4F, may contain a large amount of water (H₂O), and generally oil may have a tendency to float on the water. Therefore, when the electrolyte coating layer 220 is formed, the electrolyte coating layer 220 should be formed while reducing the possibility of and/or preventing the oil patterns 216 from floating on the electrolyte coating layer 220. For this purpose, according to an exemplary embodiment, the electrolyte coating layer 220 may be formed by slit coating.

When described in more detail, the electrolyte 220a may be provided to an upper surface of the first substrate 200 through an outlet of a slit nozzle 250 as shown in FIG. 4F, and the first substrate 200 may be moved in a lateral direction during the application of the electrolyte 220a. Accordingly, the surface, e.g., an entire surface between opposite portions of hydrophilic region 213, of the substrate 200 may be coated with the electrolyte 220a. The electrolyte 220a may be deposited as a single continuous layer.

Since the electrolyte 220a contains a large amount of water, the electrolyte 220a could be in contact with the hydrophobic layer 210 while having a relatively high contact angle. Also, the electrolyte 220a could contract in the form of a drop on the hydrophobic insulation layer 210. In contrast, according to example embodiment, since the electrolyte 220a is formed to cover both the hydrophobic insulation layer 210 and the hydrophilic region 213, the hydrophobic insulation layer 210 and the hydrophilic region 213 may be affected by different amounts of surface tension. Therefore, the electrolyte 220a may be formed on the hydrophobic insulation layer 210 and the hydrophilic region 213 while having a contact angle lower than when being formed on only a hydrophobic insulation layer.

As shown in FIG. 4G, the electrolyte coating layer 220 may be formed while having a low contact angle. Also, the difference between the heights of the electrolyte coating layer 220 on a central portion and an edge portion of the substrate 100 becomes small. Further, since adhesion in the hydrophilic region at the edges of the electrolyte coating layer 220 becomes strong, contraction of the electrolyte coating layer 220 in the form of a drop on the hydrophobic insulation layer 210 may be reduced.

In addition, the isolation walls 214 dividing each pixel may be provided as additional hydrophilic regions so that the surface area of a hydrophilic region may be increased. Therefore, dewetting defects of the electrolyte coating layer may be inhibited.

Referring to FIG. 4H, a second substrate 300 may be prepared, and light-shielding patterns 302, a color filter layer 304, and a common electrode 306 may be formed on the second substrate 300. The second substrate 300 may include, e.g., a glass substrate.

The light-shielding patterns 302 may be formed to face the isolation walls 214. The color filter layer 304 may include color filters showing different colors. The color filters may be formed to face the pixel electrodes, respectively. The color filter layer 304 may be omitted when the oil patterns 216 are configured to show colors. The common electrode 306 may be formed on the substrate 300, e.g., on the color filter layer 304 and the light-shielding patterns 302, and a common voltage may be applied thereto.

The second substrate 300 may cover the first substrate 200 having the electrolyte coating layer 220 formed thereon, and the first substrate 200 and the second substrate 300 may be bonded to each other. Thus, an electrowetting display may be completed.

In the electrowetting display, the electrolyte coating layer 220 may not contract in the form of a drop and may have a low contact angle. Therefore, virtually no dewetting defects generated due to the contraction of the electrolyte coating layer 220 may occur.

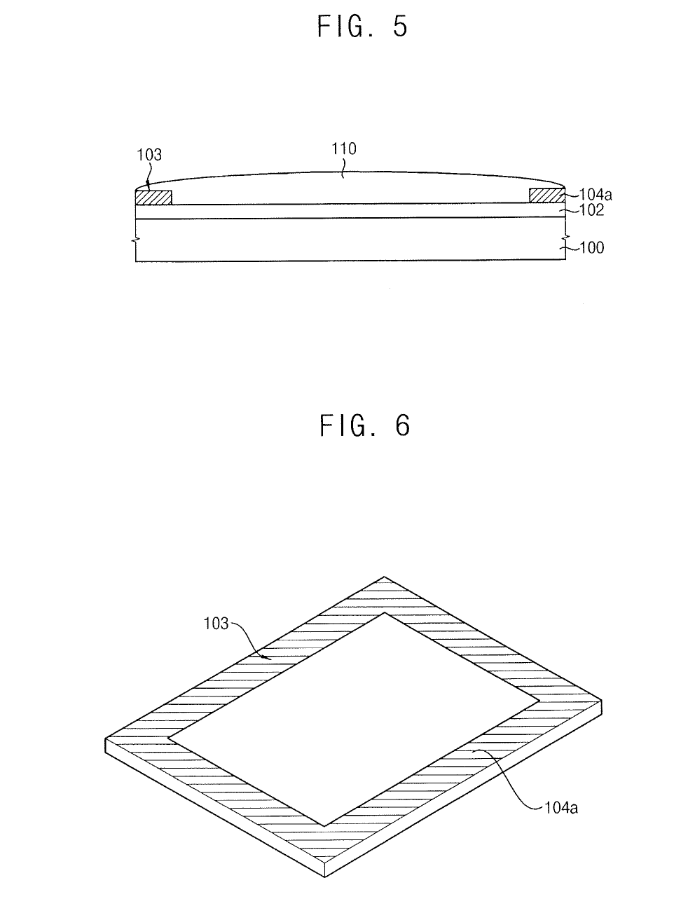

FIGS. 5 and 6 are respectively a cross-sectional view and a perspective view illustrating a coating method in accordance with an example embodiment.

A coating method described below is the same as that described with reference to FIGS. 1A to 1C except that the shape of a hydrophilic region is different.

A hydrophobic layer 102 may be formed on the entire upper surface of a substrate 100 by using the method described in FIG. 1A. Thereafter, a hydrophilic region 103 may be formed by forming a hydrophilic layer 104a to surround the outside of the coating area of the substrate 100.

As shown in FIGS. 5 and 6, the hydrophilic layer 104a may be formed while the hydrophobic layer 102 may not be allowed to be exposed outside the hydrophilic layer 104a. The hydrophilic layer 104a may extend to an edge portion of the substrate 100 while being formed outside a pixel forming region and may be thus formed to cover the edge portion of the substrate 100.

The hydrophilic region 103 may be formed, and an electrolyte layer 110 may be formed by coating the hydrophobic layer 102 and the hydrophilic region 103 to be completely covered with an electrolyte.

A hydrophilic region may be included in the substrate 100 and thus, the same effect as that described in Example Embodiment 1 may be obtained.

An electrowetting display may be manufactured by including the foregoing coating method.

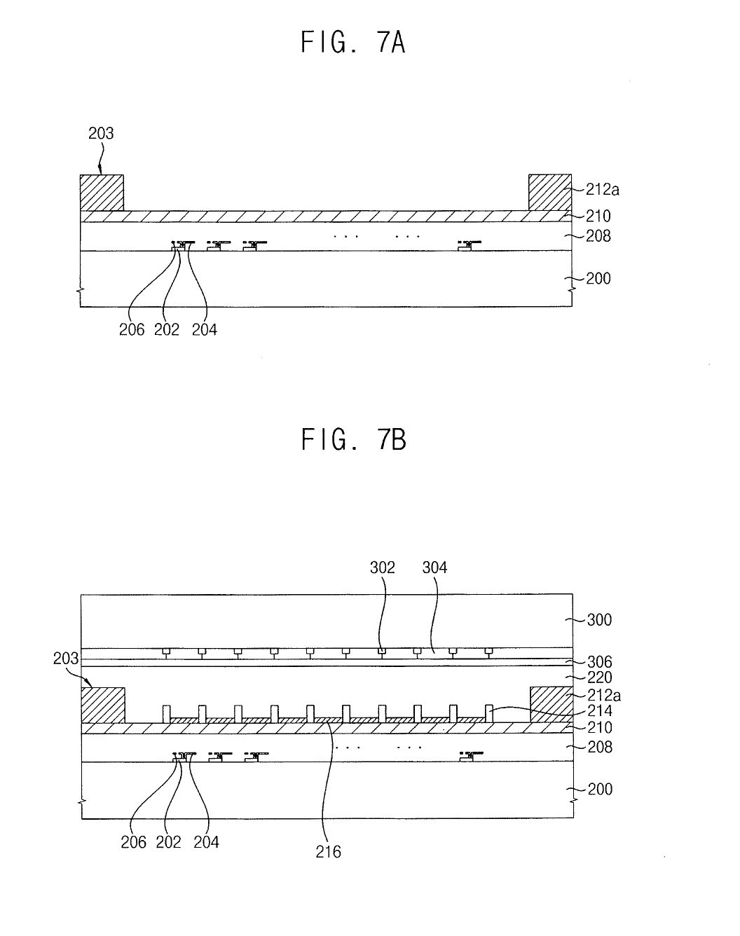

FIGS. 7A and 7B are cross-sectional views illustrating a method of manufacturing an electrowetting display in accordance with an example embodiment.

The processes described with reference to FIGS. 4A and 4B may be performed.

Thereafter, as shown in FIGS. 6 and 7A, a hydrophilic region 203 may be formed by forming a hydrophilic layer 212a to surround the outside of a pixel forming region. In the process of forming the hydrophilic region, a hydrophobic insulation layer 210 may not be allowed to be exposed outside the hydrophilic layer 212a. The hydrophilic layer 212a may extend to an edge portion of a first substrate 200 while being formed outside the pixel forming region, and may be thus formed to cover the edge portion of the first substrate 200.

Thereafter, as shown in FIG. 7B, an electrowetting display may be manufactured by performing the processes described in FIGS. 3D to 3F.

In the electrowetting display, an electrolyte coating layer 220 may not contract in the form of a drop and has a low contact angle. Therefore, virtually no dewetting defects generated due to the contraction of the electrolyte coating layer 220 may occur.

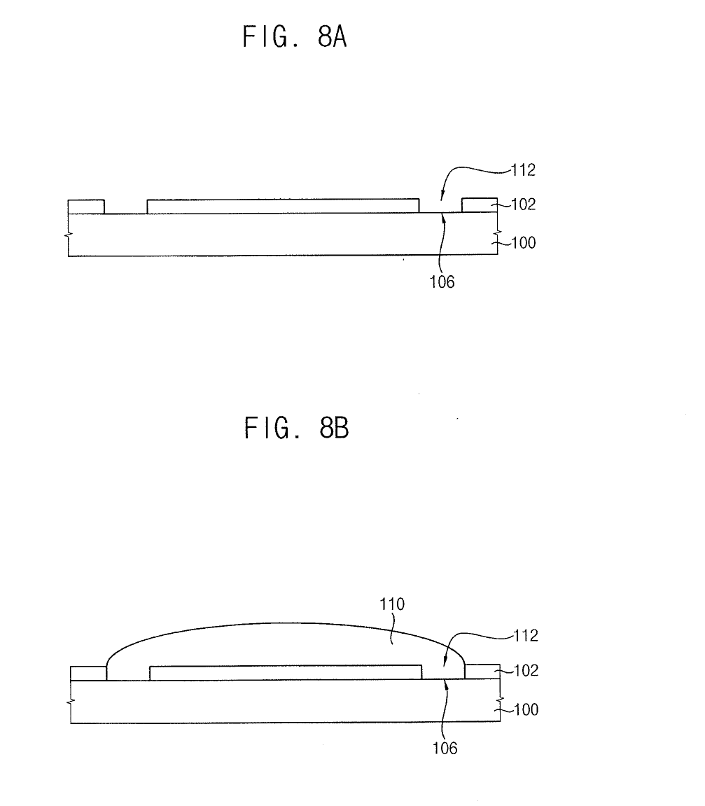

FIGS. 8A and 8B are cross-sectional views illustrating a coating method in accordance with an example embodiment.

A coating method described below is the same as that described with reference to FIGS. 1A to 1C except for the method of forming a hydrophilic region.

A hydrophobic layer 102 may be formed on the entire upper surface of a substrate 100 by using the method described in FIG. 1A. The substrate 100 may be, e.g., a glass substrate.

Referring to FIG. 8A, a hydrophilic region 106 may be formed by etching the hydrophobic layer 102 formed outside a coating area on the substrate 100. The hydrophilic region 106 may be an exposed surface portion of the substrate 100, e.g., the forming of a separate hydrophilic layer may be avoided.

That is, the hydrophilic region 106 may become the bottom of an opening 112 generated by etching the hydrophobic layer 102. A surface of the substrate 100 in the opening 112 may be relatively hydrophilic and may thus be provided as the hydrophilic region 106. The hydrophilic region 106 may have a shape similar to that of the hydrophilic region shown in FIG. 2, e.g., the opening 112 provided as the hydrophilic region 106 may have a closed-loop shape. Also, a surface of the hydrophobic layer 102 may be exposed outside the opening 112.

Referring to FIG. 8B, an electrolyte layer 110 may be formed by coating the hydrophobic layer 102 and the hydrophilic region 106 to be covered with an electrolyte. The electrolyte may fill, e.g., completely fill, the openings in the hydrophobic layer 102 that form the hydrophilic region 106. The same effect as that described in Example Embodiment 1 may be obtained even in the case in which the hydrophilic region is formed by using the foregoing method.

An electrowetting display may be manufactured by including the foregoing coating method.

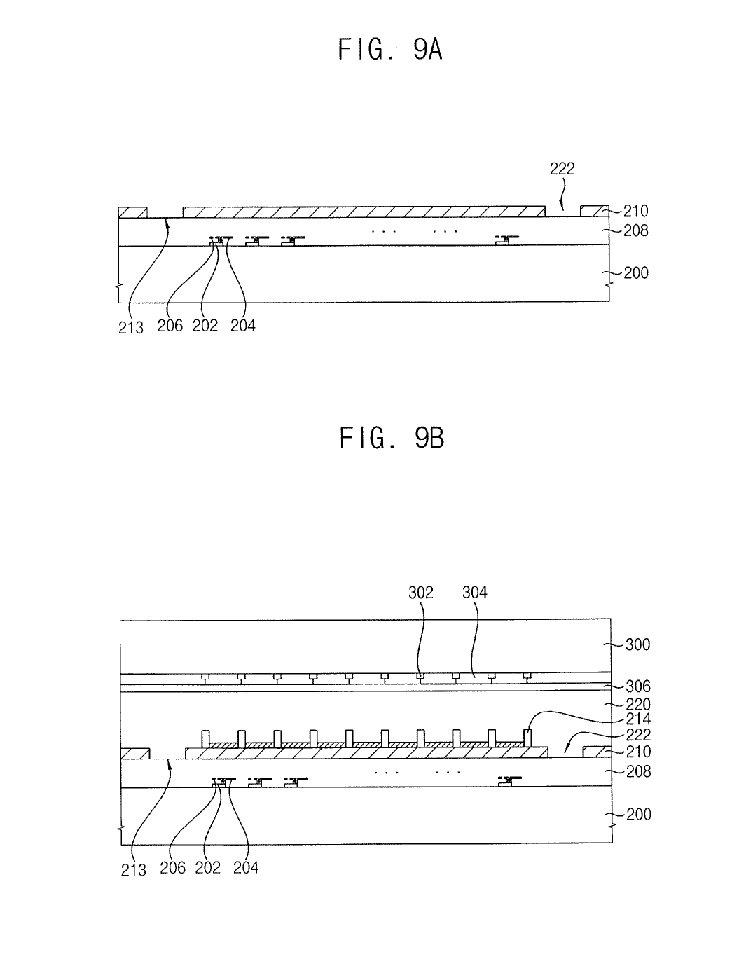

FIGS. 9A and 9B are cross-sectional views illustrating a method of manufacturing an electrowetting display in accordance with an example embodiment.

The processes described with reference to FIGS. 4A and 4B may be performed.

As shown in FIG. 9A, a hydrophilic region 213 may be formed by etching a hydrophobic insulation layer 210 formed outside a pixel forming region on the substrate 200. By the etching process, a surface portion of the substrate 100 may be exposed in an opening 222. The hydrophilic region 213 may be an exposed surface portion of the substrate 100. The hydrophilic region 213 may have a shape similar to that of the hydrophilic region shown in FIG. 2. The hydrophilic region 213 may become a bottom of the opening 222 generated by etching the hydrophobic insulation layer 210. The opening 222 may have a closed-loop shape.

Thereafter, as shown in FIG. 9B, an electrowetting display may be manufactured by performing the processes described in FIGS. 4D to 4H.

In the electrowetting display, an electrolyte coating layer 220 may not contract in the form of a drop and may have a low contact angle. Therefore, virtually no dewetting defects generated due to the contraction of the electrolyte coating layer 220 may occur.

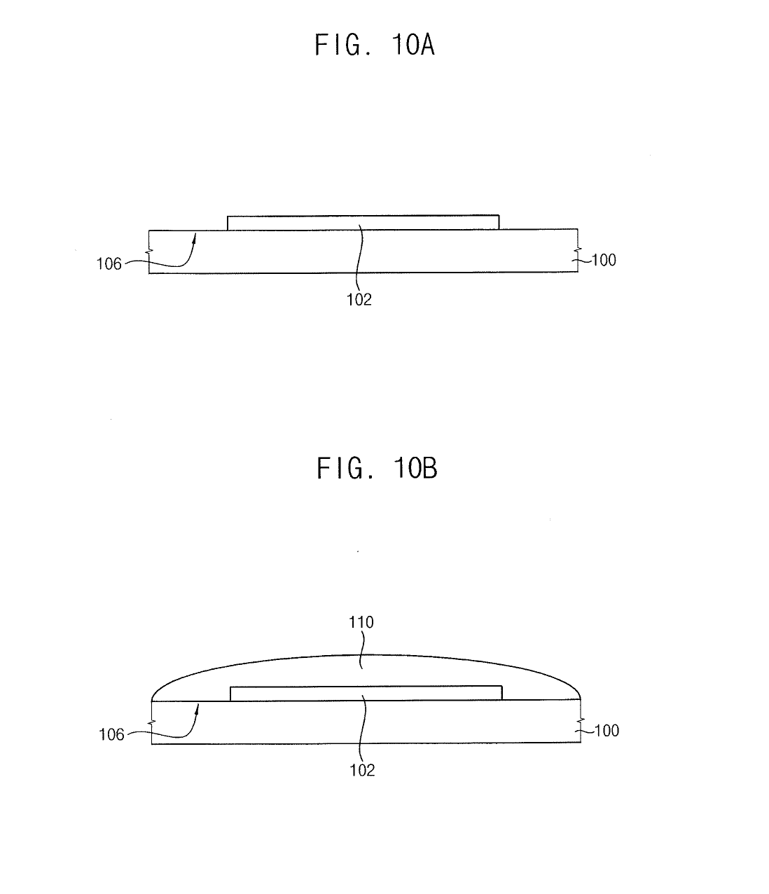

FIGS. 10A and 10B illustrate cross-sectional depicting stages in a coating method in accordance with an example embodiment. The coating method described below may be the same or substantially similar to that described with reference to FIGS. 1A to 1C, except for the method of forming a hydrophilic region.

A hydrophobic layer 102 may be formed on the entire upper surface of a substrate 100 by using the method described in FIG. 1A.

Referring to FIG. 10A, a hydrophilic region 106 may be formed by exposing a portion of a surface of the substrate 100 by etching the hydrophobic layer 102 formed outside a coating area on the substrate 100. Since the surface of the substrate 100 may be hydrophilic in comparison to the hydrophobic layer, the exposed surface portion of the substrate 100 may be provided as the hydrophilic region 106. For example,

The hydrophilic region 106 may have a shape extending from the outside of the coating area to edges of the substrate 100. The edges of the substrate 200 may not have the hydrophobic layer 102 thereon, and may correspond to the hydrophilic region 106. For example, the hydrophilic region 106 may have a shape, e.g., closed loop shape, similar to that shown in FIG. 6. Therefore, the hydrophobic layer 102 may not be formed on an edge portion, e.g., that defines an entire periphery, of the substrate 100.

Referring to FIG. 10B, an electrolyte layer 110 may be formed by coating the hydrophobic layer 102 and the hydrophilic region 106 so as to be covered, e.g., completely covered, with an electrolyte. The same effect as that described in Example Embodiment 1 may be obtained even in the case in which the hydrophilic region is formed by using the foregoing method.

An electrowetting display may be manufactured by including the foregoing coating method.

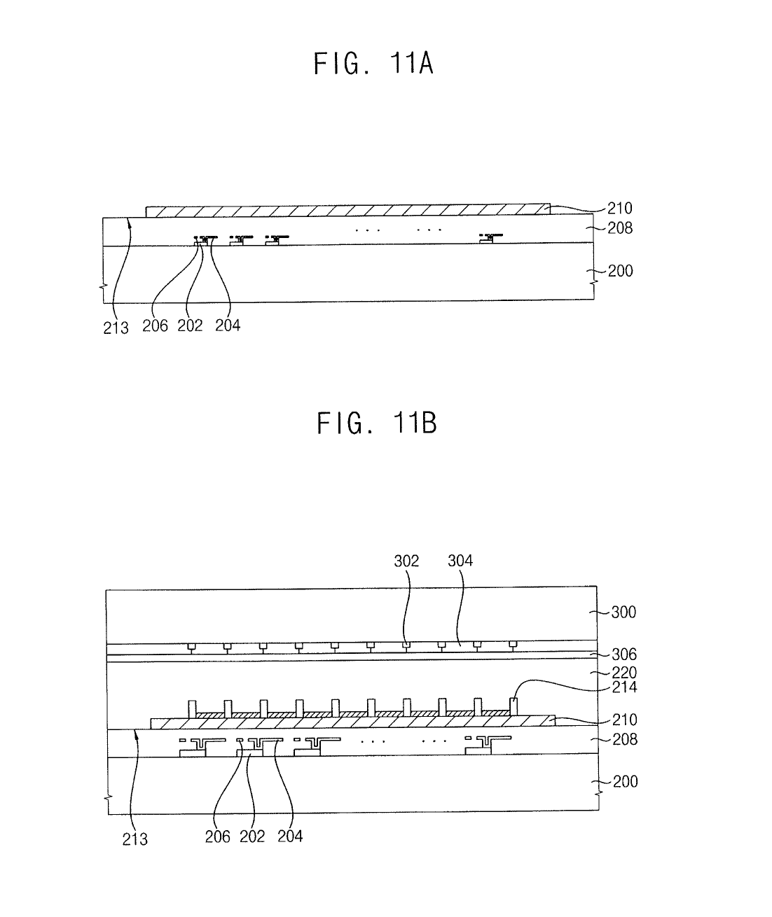

FIGS. 11A and 11B illustrate cross-sectional views depicting stages in a method of manufacturing an electrowetting display in accordance with an example embodiment.

The processes described with reference to FIGS. 4A and 4B may be performed and, as shown in FIG. 11A, a hydrophilic region 213 may be then formed by exposing a portion of a surface of a substrate 200 by etching a hydrophobic insulation layer 210 formed outside a pixel forming region on the substrate. Since the surface of the substrate 200 is hydrophilic compared to the hydrophobic layer, the exposed surface portion of the substrate 200 may be provided as the hydrophilic region 213.

The hydrophilic region 213 may have a shape extending from the outside of the pixel forming region to edges of the substrate 200. That is, the hydrophilic region 213 may have a shape similar to that shown in FIG. 6.

Thereafter, as shown in FIG. 11B, an electrowetting display may be manufactured by performing the processes described in FIGS. 4D to 4H.

In the electrowetting display, an electrolyte coating layer 220 may not contract in the form of a drop and has a low contact angle. Therefore, virtually no dewetting defects generated due to the contraction of the electrolyte coating layer 220 may occur.

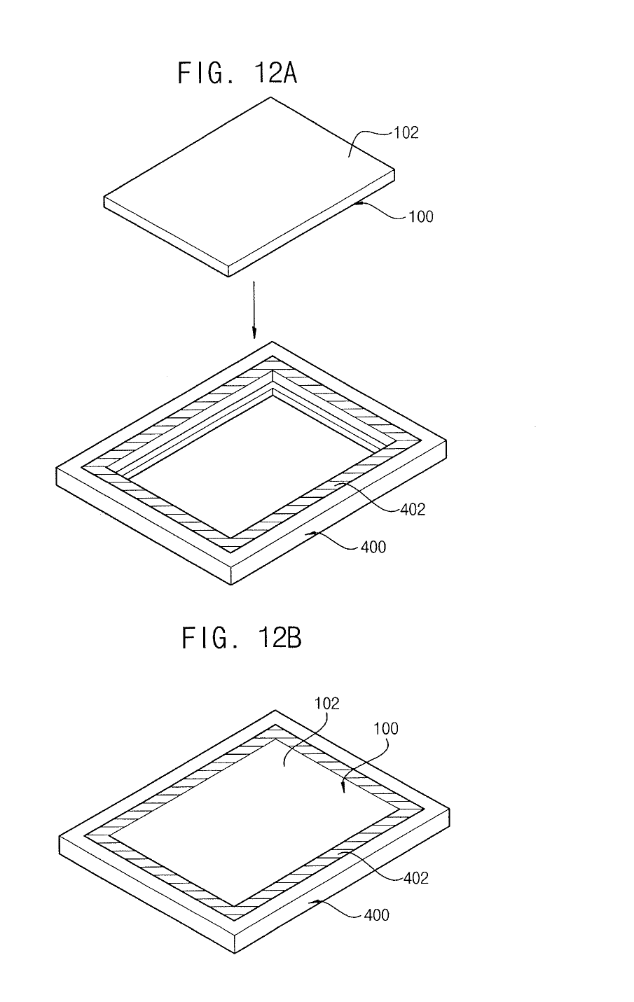

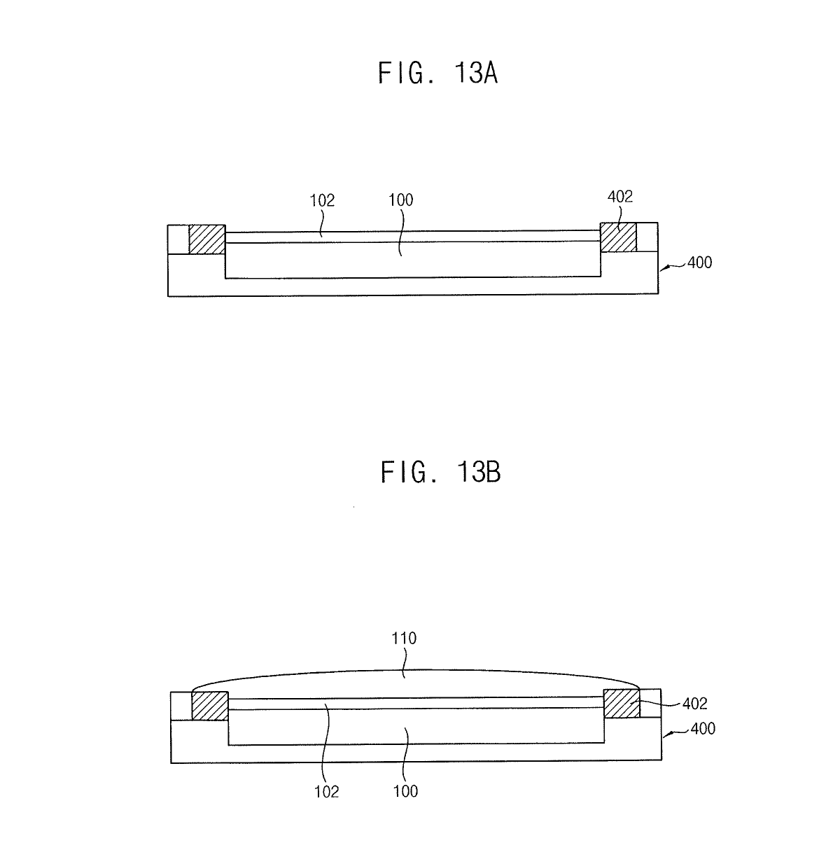

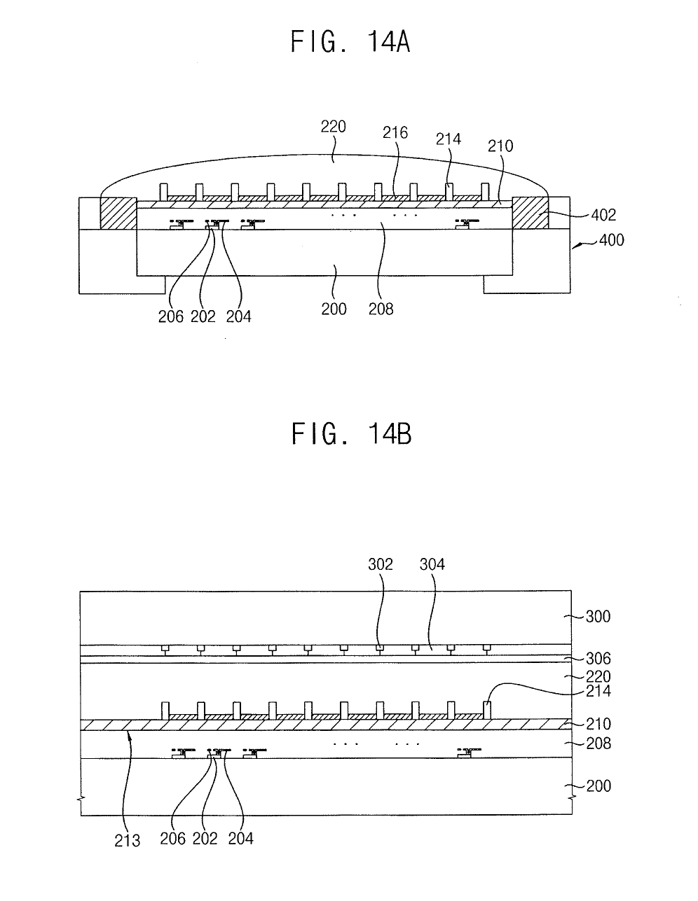

FIGS. 12A and 12B are perspective views illustrating a coating method in accordance with an example embodiment. FIGS. 13A and 13B are cross-sectional views illustrating a coating method in accordance with an example embodiment.

First, a hydrophobic layer 102 may be formed on the entire upper surface of a substrate 100 by using the method described in FIG. 1A.

Referring to FIGS. 12A, 12B, and 13A, the substrate 100 having the hydrophobic layer 102 formed thereon may be loaded on a chuck 400. The chuck 400 may have a shape for supporting a bottom of the substrate 100.

When the substrate 100 is loaded on the chuck 400, a portion of the chuck 400 surrounding an edge portion of the substrate 100 may include a hydrophilic region 402. For example, the portion of the chuck 400 in contact with sidewalls of the edges of the substrate 100 may become the hydrophilic region 402. The hydrophilic region 402 may be hydrophilic in comparison to a surface of the hydrophobic layer.

For example, the hydrophilic region 402 on the chuck 400 may include a hydrophilic layer. The hydrophilic region 402 may have a closed-loop shape to surround the edge portion of the substrate 100. For example, the outside of edges of the hydrophilic region 402 may comprise a material having hydrophobicity, i.e., only a partial portion of the chuck 400 includes the hydrophilic region 402. As another example, the entire upper surface of the chuck 400 surrounding the edge portion of the substrate 100 may be the hydrophilic region 402.

Thus, the hydrophilic region 402 may not be disposed in the substrate 100, but may be disposed outside the substrate 100. A surface, e.g., an entirety of a surface, of the substrate 100 may correspond to a hydrophobic layer 102.

Also, when the substrate 100 is loaded on the chuck 400, the hydrophilic region 402 may be disposed higher than the upper surface of the substrate 100. According to another exemplary embodiment, when the substrate 100 is loaded on the chuck 400, the hydrophilic region 402 may be disposed on the same plane as the upper surface of the substrate 100 or disposed lower than the upper surface of the substrate 100.

Referring to FIG. 13B, an electrolyte layer 110 may be formed by coating the hydrophobic layer 102 on the substrate 100 and the hydrophilic region 402 included in the chuck so as to be cover, e.g., completely covered, with an electrolyte.

The electrolyte layer 110 may be formed through, e.g., slit coating. For example, the electrolyte may be provided to the substrate 100 and the upper surface of the chuck 400 through an outlet of a slit nozzle, and the substrate 100 loaded on the chuck 400 may be moved in a lateral direction by moving the chuck 400. Therefore, the surface, e.g., the entire surface, of the substrate 100 and at least the hydrophilic region 402 of the chuck 400 may be coated with the electrolyte.

The electrolyte may be formed to cover, e.g., completely cover, the hydrophobic layer 102 of the substrate 100 and the hydrophilic region 402 of the chuck 400. When the electrolyte is formed to cover both the hydrophobic layer 102 and the hydrophilic region 402, the hydrophobic layer 102 and the hydrophilic region 402 may be affected by different amounts of surface tension.

For example, the electrolyte may have a shape covering the hydrophobic layer 102 formed on the substrate while strongly adhering to the hydrophilic region 402. Also, the electrolyte layer may be formed to cover the upper surface of the hydrophobic layer 102 while not contracting in the form of a drop and having a low contact angle. Therefore, virtually no dewetting defects generated due to the contraction of the electrolyte may occur in the electrolyte layer.

An electrowetting display may be manufactured by including the foregoing coating method.

FIGS. 14A and 14B illustrate cross-sectional views depicting stages in a method of manufacturing an electrowetting display in accordance with an example embodiment.

A hydrophobic insulation layer 210 may be formed on the substrate 200 by performing the processes described with reference to FIGS. 4A and 4B. Thereafter, isolation walls 214 providing an isolated inner space for each pixel may be formed on the hydrophobic insulation layer 210 by performing the process described with reference to FIG. 4D. The isolation walls 214 may be formed to have hydrophilicity, and surfaces of the isolation walls 214 may be provided as additional hydrophilic regions. Also, oil patterns 216 may be formed inside the isolation walls 214. Next, as shown in FIG. 14A, the substrate 200 may be loaded on a chuck 400. The chuck 400 may be formed to support a bottom of the substrate 200.

When the substrate 200 is loaded on the chuck 400, a portion of chuck 400 surrounding an edge portion of the substrate 200 may include a hydrophilic region 402. That is, the portion of the chuck 400 in contact with sidewalls of the edges of the substrate 200 may become the hydrophilic region 402. The hydrophilic region 402 may have a closed-loop shape to surround the edge portion of the substrate 200. For example, the hydrophilic region 402 may not be disposed in the substrate 200, but may be disposed outside the substrate 200.

An electrolyte coating layer 220 may be formed by coating the hydrophobic insulation layer 210 on the substrate 200 and the hydrophilic region 402 included in the chuck 400 so as to be covered, e.g., completely covered, with an electrolyte solution. The process of forming the electrolyte coating layer 220 may be the same as that described with reference to FIGS. 4F and 4G.

Referring to FIG. 14B, a second substrate 300 may be prepared, and light-shielding patterns 302, a color filter layer 304, and a common electrode 306 may be formed on the second substrate 300. The second substrate 300 may include, e.g., a glass substrate.

The light-shielding patterns 302 may be formed to face the isolation walls 214. The color filter layer 304 may include color filters showing different colors. The color filters may be formed to face the pixel electrodes, respectively. The color filter layer 304 may be omitted when the oil patterns 216 are configured to show colors. The common electrode 306 may be formed on the substrate 300 and/or on the color filter layer 304, and a common voltage may be applied thereto.

The second substrate 300 may cover a first substrate 200 having the electrolyte coating layer 220 formed thereon, and the first substrate 200 and the second substrate 300 may be bonded to each other. Thus, an electrowetting display may be formed.

In the electrowetting display, the electrolyte coating layer 220 may not contract in the form of a drop and has a low contact angle. Therefore, virtually no dewetting defects generated due to the contraction of the electrolyte coating layer 220 may occur.

FIGS. 15A and 15B illustrate cross-sectional views depicting stages in a coating method in accordance with an example embodiment. Hereinafter, a method of forming an electrolyte layer on a hydrophobic layer will be described.

Referring to FIG. 15A, a hydrophobic layer 102 may be formed on the entire upper surface of a substrate 100. For example, the hydrophobic layer 102 may be formed by using the method described in FIG. 1A.

Isolation walls 105 exposing a portion of the hydrophobic layer may be positioned in a coating area to be coated with an electrolyte layer on the substrate. For example, inner spaces may be generated by the isolation walls 105. The isolation walls 105 may include a material having a higher hydrophilicity than the hydrophobic layer. Therefore, surfaces of the isolation walls 105 may be provided as hydrophilic regions.

Referring to FIG. 15B, an electrolyte layer 110 may be formed by coating the hydrophobic layer 102 and the isolation walls so as to be completely covered with an electrolyte. The electrolyte layer 110 may be formed by using the method described in FIG. 1C.

Since the isolation walls included in the coating area are hydrophilic, the electrolyte may be formed while being strongly adhered to the isolation walls. Therefore, the electrolyte layer 110 may not contract in the form of a drop and dewetting defects are also decreased.

Hereinafter, a method of manufacturing an electrowetting display including the foregoing coating method will be described.

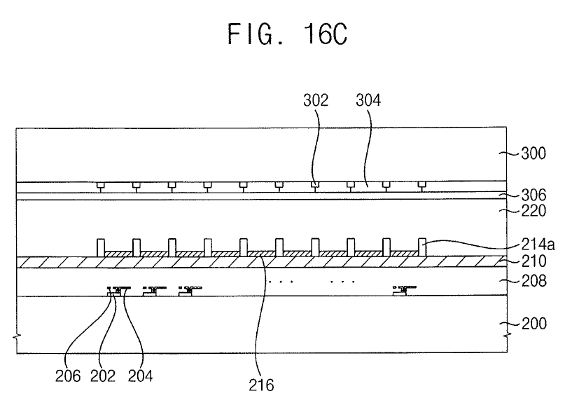

FIGS. 16A to 16C are cross-sectional views illustrating a method of manufacturing an electrowetting display in accordance with an example embodiment.

First, processes described with reference to FIGS. 4A and 4B may be performed.

Next, referring to FIG. 16A, isolation walls 214a providing an isolated inner space for each pixel may be formed on a hydrophobic insulation layer 210. That is, the inner spaces formed by the isolation walls 214a may correspond to respective pixels. The isolation walls 214a, for example, may include a photoresist. The isolation walls 214a may be formed to have hydrophilicity. For example, the isolation walls 214a may be formed by using a hydrophilic material. The hydrophilic material may have a higher hydrophilicity than the hydrophobic insulation layer. Otherwise, the isolation walls 214a may be formed by a selective hydrophilic treatment of the isolation walls 214a. For example, surfaces of the isolation walls 214a may be provided as hydrophilic regions.

Referring to FIG. 16B, each inner space formed by the isolation walls 214a may be coated with oil to form oil patterns 216. The process of forming the oil patterns 216 may be the same as that described with reference to FIG. 4E.

Thereafter, an electrolyte coating layer 220 may be formed on the oil patterns 216 to cover, e.g., completely cover, the hydrophobic insulation layer 210 and the isolation walls 214a. An exemplary method of forming the electrolyte coating layer 220 was described with reference to FIG. 4F.

Since the electrolyte coating layer 220 is formed to cover both the hydrophobic insulation layer 210 and the hydrophilic region 213, the hydrophobic insulation layer 210 and the hydrophilic region 213 may be affected by different amounts of surface tension. Therefore, the electrolyte coating layer 220 may be formed on the hydrophobic insulation layer 210 and the hydrophilic region 213 while having a contact angle lower than when being formed on the hydrophobic insulation layer 210 alone.

As shown in FIG. 16B, the electrolyte layer 220 may be formed while having a low contact angle. The difference between the heights of the electrolyte coating layer 220 on a central portion and an edge portion of the substrate 100 may become small. Further, since adhesion in the hydrophilic region at the edges of the electrolyte coating layer 220 becomes strong, contraction of the electrolyte coating layer 220 in the form of a drop on the hydrophobic insulation layer 210 may be reduced.

In addition, isolation walls 214a dividing each pixel may be provided as additional hydrophilic regions and thus, the surface area of the hydrophilic region may be increased. Therefore, dewetting defects of the electrolyte coating layer may be inhibited.

Referring to FIG. 16C, a second substrate 300 may be prepared, and light-shielding patterns 302, a color filter layer 304, and a common electrode 306 may be formed on the second substrate 300. The second substrate 300 may include, e.g., a glass substrate.

The light-shielding patterns 302 may be formed to face the isolation walls 214a. Also, the color filter layer 304 may include color filters showing different colors. The color filters may be formed to face the pixel electrodes, respectively. The common electrode 306 may be formed on the color filter layer 304, and a common voltage may be applied thereto.

The second substrate 300 may cover the first substrate 200 having the electrolyte coating layer 220 formed thereon, and the first substrate 200 and the second substrate 300 may be bonded to each other. Thus, an electrowetting display may be completed.

In the electrowetting display, the electrolyte coating layer 220 may not contract in the form of a drop and has a low contact angle. Therefore, virtually no dewetting defects generated due to the contraction of the electrolyte coating layer 220 may occur.

By way of summation and review, the electrowetting display uses the principles of hydrophobic and hydrophilic interactions between a substrate and an electrolyte to display images. Oil may be introduced into a display panel and a voltage may be applied to the electrolyte to control the gathering and dispersing of an oil. When no voltage is applied, light may be absorbed or not transmitted because the oil covers the entire substrate. Since the substrate is hydrophobically treated, the substrate tries to repulse the electrolyte, and thus, oil is disposed between the substrate and the electrolyte. Yet, since the substrate attracts the electrolyte when the voltage is applied, oil is pushed toward isolation walls, and the electrolyte comes into contact with the substrate. Therefore, contrast ratio is adjusted according to the amount of oil that moves, so as to reproduce color.

To manufacture the electrowetting display, an oil layer and an electrolyte layer may be sequentially disposed on the substrate. However, since the oil layer generally floats on the electrolyte layer, it is not easy to form the oil layer to be stably disposed under the electrolyte layer. Also, since the substrate is hydrophobic, it is easy for the electrolyte to contract in the form of drops when the amount of the electrolyte is small, so that a portion not coated with the electrolyte (a dewetting portion) may be formed. In other words, since the substrate has a hydrophobic surface, dewetting conditions may be facilitated due to the contraction of the electrolyte in the form of drops during the coating of the electrolyte on the substrate. Therefore, it may be difficult to use a general coating method such as an inkjet technique or a slit coating technique, which in turn decreases the mass productivity of electrowetting displays. Further, a considerable amount of the electrolyte may be used to form the electrolyte layer.

In contrast, embodiments relate to improved methods of coating an electrolyte layer and methods of manufacturing an electrowetting display by using the same. Further, embodiments relate to a coating method for coating an electrolyte layer while reducing the possibility of and/or preventing contraction of the electrolyte layer, and a method of manufacturing an electrowetting display by using the coating method. Embodiments also relate to a method of manufacture an electrowetting display that includes forming a hydrophobic layer in a coating area and a hydrophilic region outside the coating area during. Thereafter, an electrolyte layer covering both the hydrophobic layer and the hydrophilic region may be formed. Further, since the adhesion of the electrolyte layer in the hydrophilic region may be increased, coating of the electrolyte layer may be performed without dewetting conditions.

For example, according to embodiments, the electrolyte layer may have a shape covering the hydrophilic region and the hydrophobic layer. Therefore, the adhesion of the electrolyte layer in the hydrophilic region may be increased, so that the adhesion characteristics at the edges of the electrolyte layer may be improved. Also, since the electrolyte layer has a shape covering the hydrophilic region and the hydrophobic layer, the contact angle of the electrolyte layer may be greatly reduced as compared to the case in which the electrolyte layer is only formed on the hydrophobic layer. Therefore, dewetting defects due to the contraction of electrolyte in the form of a drop may be decreased in the electrolyte layer.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method of coating an electrolyte layer on a substrate, the method comprising:
forming a hydrophobic layer on an upper surface of the substrate that has a coating area;
forming a hydrophilic region having a shape surrounding an outside of the coating area; and
forming the electrolyte layer to cover the hydrophobic layer and the hydrophilic region.

2. The method as claimed in claim 1, wherein forming the hydrophilic region includes forming a hydrophilic layer on the hydrophobic layer.

3. The method as claimed in claim 1, wherein forming the hydrophilic region includes removing portions of the hydrophobic layer in the hydrophilic region.

4. The method as claimed in claim 1, wherein the hydrophilic region is positioned outside the substrate and is formed to surround sidewalls of the substrate.

5. The method as claimed in claim 4, wherein the hydrophilic region is positioned at an upper surface of a chuck for surrounding at least a portion of the sidewalls of the substrate and for supporting a bottom of the substrate.

6. The method as claimed in claim 1, wherein forming the electrolyte layer includes:
moving the substrate in a lateral direction while an electrolyte discharged from one end portion of a nozzle is provided to the upper surface of the substrate; and
forming the electrolyte layer includes allowing the electrolyte to cover the hydrophobic layer while the electrolyte has a relatively strong adhesion to the hydrophilic region.

7. A method of manufacturing an electrowetting display, the method comprising:
forming a hydrophobic insulation layer on a first substrate having a pixel region, the pixel region including pixel electrodes formed on the first substrate;
forming a hydrophilic region having a shape surrounding an outside of the pixel region;
forming oil patterns on portions of the first substrate corresponding to the pixel electrodes, respectively;
forming an electrolyte coating layer on the oil patterns, the electrolyte coating layer being formed to cover the hydrophobic insulation layer and the hydrophilic region; and
covering the first substrate with a second substrate.

8. The method as claimed in claim 7, wherein forming the hydrophilic region includes forming a hydrophilic layer on the hydrophobic insulation layer.

9. The method as claimed in claim 7, wherein the hydrophilic region is positioned outside the substrate and is formed to surround sidewalls of the substrate.

10. The method as claimed in claim 7, wherein a surface of the hydrophobic insulation layer is exposed outside the hydrophilic region.

11. The method as claimed in claim 7, wherein the hydrophilic region is formed by attaching a thin film, which thin film includes a material having a hydrophilic group, onto the hydrophobic insulation layer.

12. The method as claimed in claim 7, wherein forming the hydrophilic region includes:
forming a thin film, which thin film includes a material having a hydrophilic group, on the substrate; and
patterning the thin film through a photolithography process.

13. The method as claimed in claim 7, wherein forming the electrolyte coating layer includes forming an electrolyte layer by allowing the electrolyte to completely cover the hydrophobic layer while the electrolyte has a relatively strong adhesion to the hydrophilic region.

14. The method as claimed in claim 7, further comprising forming isolation walls on the hydrophobic insulation layer, the isolation walls corresponding to pixel boundaries, respectively, in the pixel region.

15. The method as claimed in claim 14, wherein:
the oil patterns are formed on portions of the hydrophobic layer isolated by the isolation walls, and
the isolation walls include a material having a higher hydrophilicity than the hydrophobic insulation layer.

16. A method of manufacturing an electrowetting display, the method comprising:
providing a first substrate having a pixel region formed thereon, the pixel region including a plurality of pixels;
forming a hydrophobic insulation layer above the pixel region;
forming a hydrophilic region in a non-overlapping relationship with the pixel region;
forming oil patterns that are above the pixel region and excluded from being above the hydrophilic region;
forming a single electrolyte coating layer covering the hydrophobic insulation layer, the oil patterns, and the hydrophilic region; and
providing a second substrate on the first substrate to enclose the electrolyte coating layer between the first and second substrates.

17. The method as claimed in claim 16, wherein the electrolyte coating layer is directly on the hydrophobic insulation layer, the oil patterns, and the hydrophilic region.

18. The method as claimed in claim 16, further comprising forming isolation walls that overlap the pixel region, each of the oil patterns being arranged between adjacent ones of the isolation walls, wherein:
the isolation walls define secondary hydrophilic regions that are on the hydrophobic insulation layer and that are enclosed by the hydrophilic region, and
the electrolyte coating layer is directly on uppermost sides of the oil patterns and the isolation walls, and the electrolyte coating layer is in direct contact with a hydrophilic surface within the hydrophilic region.

19. The method as claimed in claim 16, wherein:
the hydrophilic region is defined by a hydrophilic layer foamed on the hydrophobic insulation layer or by an exposed portion of the substrate,
the electrolyte coating layer covers an uppermost side of the hydrophilic layer or the exposed portion of the substrate, and
a closed-loop shape of the hydrophilic region may enclose the oil patterns.

20. The method as claimed in claim 16, further comprising forming isolation walls that overlap the pixel region, each of the oil patterns being arranged between adjacent ones of the isolation walls,
wherein the isolation walls define secondary hydrophilic regions enclosed by the hydrophilic region.
